(19) United States
(12) Patent Application Publication
(10) Pub. No.: US 2006/0049113 A1
(43) Pub. Date: Mar. 9, 2006

(54) Methods and systems for developing compact human-engineered water remediation processes mimicking natural processes

(76) Inventors: Robert J. Congel, Fayetteville, NY (US); Robert D. Lusk, Sadler, TX (US)

Correspondence Address: JEFFREY L. BRANDT;c/o PORTFOLIO IP, P.O. BOX 52050, MINNEAPOLIS, MN, 55402, US

(21) Appl. No.: 11/212,493

(22) Filed: Aug. 26, 2005

Related U.S. Application Data
(60) Provisional application No. 60/607,232, filed on Sep. 3, 2004.

(51) Int. Cl. B01D 21/30; C02F 1/00

(52) U.S. Cl. 210/739; 210/143

(57) ABSTRACT

Methods and systems for designing and implementing water treatment facilities that are compatible with and complimentary to human environments such as residential environments and recreational environments. Esthetically pleasing, human-friendly features and facilities provide water treatment, enabling water treatment processes and facilities to exist in human-friendly environments such as residential neighborhoods and recreational facilities.

### BACKGROUND

Currently, existing water treatment facilities are large, complex, often unattractive and odorific and not compatible with human residential and recreational facilities. Water treatment facilities are often placed in less-desirable areas, making those areas inhospitable to and/or uncomfortable for human use.

### SUMMARY OF THE INVENTION

The present invention provides methods and systems for designing and implementing water treatment facilities that are compatible with and complimentary to human environments such as residential environments and recreational environments. More particularly, the present invention makes use of esthetically pleasing, human-friendly features and facilities to provide water treatment, enabling water treatment processes and facilities to exist in human-friendly environments such as residential neighborhoods and recreational facilities.

### DESCRIPTION OF THE DRAWING FIGURES

These and other objects, features and advantages of the invention will be apparent from a consideration of the detailed description of the invention when read in conjunction with the drawing Figures, in which:

FIG. 1 is a block diagram of a water processing system implemented in accordance with the present invention; and

FIG. 2 is a flow chart describing a process for designing and implementing a water processing system in accordance with the present invention.

### DETAILED DESCRIPTION OF THE INVENTION

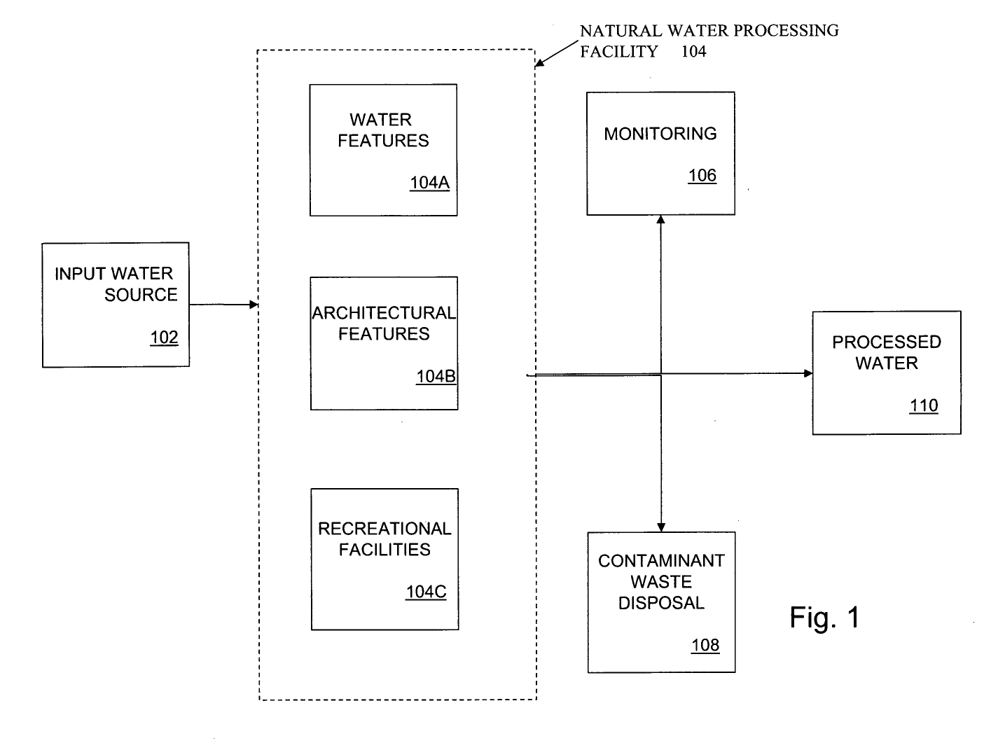

With reference to FIG. 1, there is shown a water processing system 100 including an input water source such as grey water, near-potable water or other processed water from which solids have been removed and which it is desirable to further clean. A natural water processing facility 104 is implemented, for example within human residential and recreational areas, the facility 104 including water processing systems compatible with and complimentary to human habitats. Exemplary processing systems include: i) water features such as water falls, fountains and re-circulating pools, ii) architectural features such as rock features, walls and such incorporating water processing facilities such as specialized and specific separation materials, sand sieves, and contaminant removal systems, etc. and iii) actual recreational facilities adapted to process water such as golf course ponds, community ponds and other recreational facilities adapted to process relatively clean water.

It will be understood by the reader that in some instances the water treatment feature or facility may comprise a naturally occurring item, such as a pond used for its natural filtration capabilities. In other instances the water treatment feature or facility may comprise a naturally occurring item such as a rock or sand field engineered to provide the necessary function. In still other instances the water treatment feature or facility may comprise a totally engineered item designed and fabricated to integrate into and/or be hidden in the desired location. In many embodiments the overall facility 104 will comprise a combination of these features and facilities.

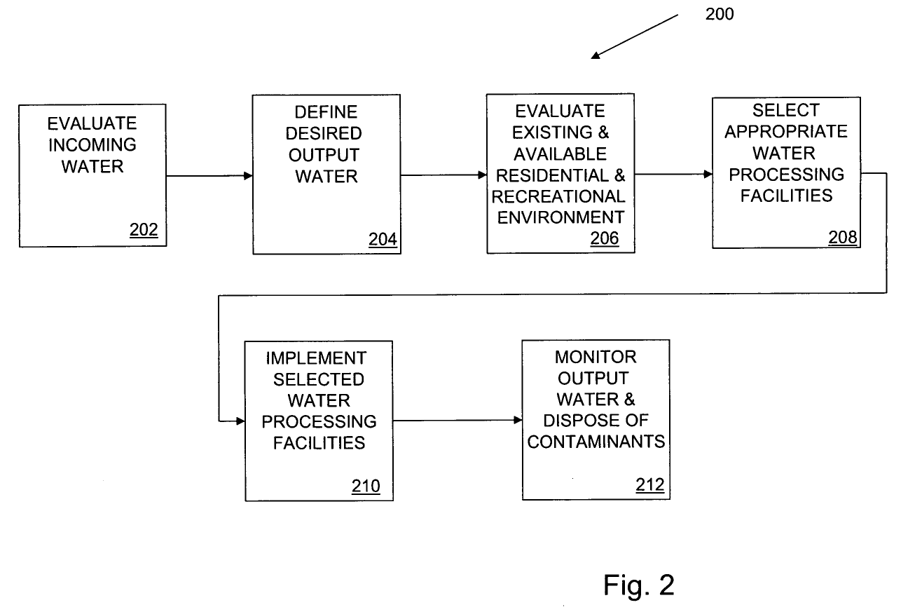

With reference to FIG. 2 there is shown a process 200 for designing and implementing human-friendly water treatment facilities in accordance with the present invention. With reference to FIG. 2, the incoming water quality is evaluated (step 202) and the desired output water qualities are defined (step 204). There is then evaluated the existing human environment available to support water treatment facilities (step 206) including residential environments and recreational environments.

Once input and output water qualities are defined and available environments and neighborhoods are evaluated, appropriate water processing features and facilities are selected. These features and facilities are selected based upon several criteria, including: i) compatibility with the available human environment, and ii) ability to provide the desired water processing results. It will be understood that numerous water processing facilities are available which are ‘human friendly’ including but not limited to: ponds, waterfalls, rock and landscape formations, buried/underground facilities and others.

Upon selecting the appropriate water processing facilities (step 208) they are implemented (step 210). Output water contaminants removed by the facilities are appropriately disposed of and output water quality is monitored (step 212). Based on monitored water quality corrections are made to the treatment systems including residence times in the treatment facility of choice. Additional facilities can be designed and implemented as necessary based upon changes in the input water quality and/or output water quality.

There have thus been provided methods and systems for implementing water treatment facilities which are compatible with and potentially beneficial to human residential and recreational facilities. When used in lieu of traditional, human-unfriendly water treatment facilities, the invention enables water processing to occur in a manner beneficial to human habitation, allowing previously unavailable geographical areas and residential and recreational facilities to be incorporated into a comprehensive water treatment system.

What is claimed is:

1. A method for processing water in a human-friendly manner, comprising:
evaluating the quality of incoming water;
defining the desired quality of outgoing water;
evaluating residential and recreational facilities available to support water processing systems;
selecting water processing systems capable of processing the incoming water to produce the outgoing water of the desired quality and which are compatible with selected residential and recreational facilities; and
implementing the selected water processing systems.
